(19) United States
(12) Patent Application Publication
(10) Pub. No.: US 2026/0260166 A1
(43) Pub. Date: Sep. 3, 2026

(54) LEARNING METHOD AND INFORMATION PROCESSING APPARATUS

(71) Applicant: Fujitsu Limited, Kawasaki-shi (JP)

(72) Inventors: Yoshinobu IIMURA, Kawasaki (JP); Masatoshi OGAWA, Zama (JP); Takashi SEYAMA, Kawasaki (JP); Ryota KOSAKA, Kawasaki (JP); Nobukazu FUDABA, Yokohama (JP)

(73) Assignee: Fujitsu Limited, Kawasaki-shi (JP)

(21) Appl. No.: 19/547,781

(22) Filed: Feb. 24, 2026

(30) Foreign Application Priority Data
Feb. 28, 2025 (JP) 2025-031424

(51) Int. Cl. G06N 20/00

(52) U.S. Cl. CPC G06N 20/00

(57) ABSTRACT

A storage unit stores training data. A processing unit determines a first function (or “bit error function”) that expresses an expected value of a number of bit errors in a transmission signal to be reconstructed from a received signal using an estimation value of a channel. The processing unit determines an expected value of the number of bit errors for a plurality of candidates of the estimation value of the channel using training data and the first function, and determines a second function that approximates the first function based on the determined expected value. The processing unit trains a machine learning model, which has the second function as a loss function, using the training data.

### CROSS-REFERENCE TO RELATED APPLICATION

This application is based upon and claims the benefit of priority of the prior Japanese Patent Application No. 2025-031424, filed on Feb. 28, 2025, the entire contents of which are incorporated herein by reference.

### FIELD

The embodiments discussed herein relate to a learning method and an information processing apparatus.

### BACKGROUND

In wireless communication such as an orthogonal frequency division multiplexing (OFDM) scheme, a received signal may deteriorate due to fading, and bit errors may occur in a reconstructed transmission signal. For this reason, a channel value that reflects the characteristics of the fading is estimated, and the transmission signal is reconstructed using the estimation value for the channel and the received signal.

In the past, a technique of generating a machine learning model using a transmission path response of a received signal in an OFDM scheme or data based on the transmission path response as an explanatory variable and using a needed carrier-to-noise ratio (C/N) deterioration amount on the transmission path as an objective variable has been proposed (see, for example, Japanese Laid-open Patent Publication No. 2024-46875). In another proposed technique, a jammer signal is suppressed using a neural network that has been trained to convert a sequence of complex numbers of a received signal into an image of real numbers and remove image noise (see, for example, Japanese Laid-open Patent Publication No. 2020-150539). As another example, a channel estimation technique that uses a neural network has been proposed (see, for example, U.S. Patent Application Publication No. 2024/0259121 and U.S. Patent Application Publication No. 2023/0261910).

### SUMMARY

In one aspect, there is provided a non-transitory computer-readable recording medium storing therein a computer program that causes a computer to execute a process including: determining a first function that expresses an expected value of a number of bit errors in a transmission signal to be reconstructed from a received signal using an estimation value of a channel; determining the expected value for a plurality of candidates of the estimation value using training data and the first function; determining a second function that approximates the first function based on the determined expected value; and training a machine learning model, which uses the second function as a loss function, using the training data.

The object and advantages of the invention will be realized and attained by means of the elements and combinations particularly pointed out in the claims

It is to be understood that both the foregoing general description and the following detailed description are exemplary and explanatory and are not restrictive of the invention.

### BRIEF DESCRIPTION OF DRAWINGS

FIG. 1 depicts one example of a learning method according to a first embodiment;

FIG. 2 depicts one example of a reconstructed transmission signal;

FIG. 3 illustrates a basic unit of a signal in an OFDM system;

FIG. 4 depicts one example of channel estimation in an OFDM scheme;

FIG. 5 depicts one example of the number of bit errors;

FIG. 6 is a block diagram depicting example hardware of an information processing apparatus;

FIG. 7 is a block diagram depicting example functions of an information processing apparatus;

FIG. 8 depicts a relationship between a difference between an estimation value and a true value of a channel and an expected value of the number of bit errors;

FIG. 9 depicts one example of a simulation result of an expected value of the number of bit errors;

FIG. 10 depicts examples of expected values of an averaged number of bit errors when the modulation scheme is QPSK;

FIG. 11 depicts examples of expected values of an averaged number of bit errors when the modulation scheme is 16 quadrature amplitude modulation (16QAM);

FIG. 12 depicts one example results of fitting the function g when the modulation scheme is QPSK;

FIG. 13 depicts one example results of fitting the function g when the modulation scheme is 16QAM;

FIG. 14 is a flowchart depicting a processing procedure of a learning method according to the second embodiment; and

FIG. 15 depicts an evaluation result indicating a relationship between the number of parameters of the machine learning model and the number of bit errors.

### DESCRIPTION OF EMBODIMENTS

When a channel value is accurately estimated using a machine learning model, the number of parameters of the machine learning model increases, which means an increase in calculation load and memory usage, thereby increasing overheads. On the other hand, to reduce the number of bit errors, it may be sufficient to not estimate the channel value with high accuracy.

Several embodiments of the present disclosure will now be described with reference to the drawings.

### First Embodiment

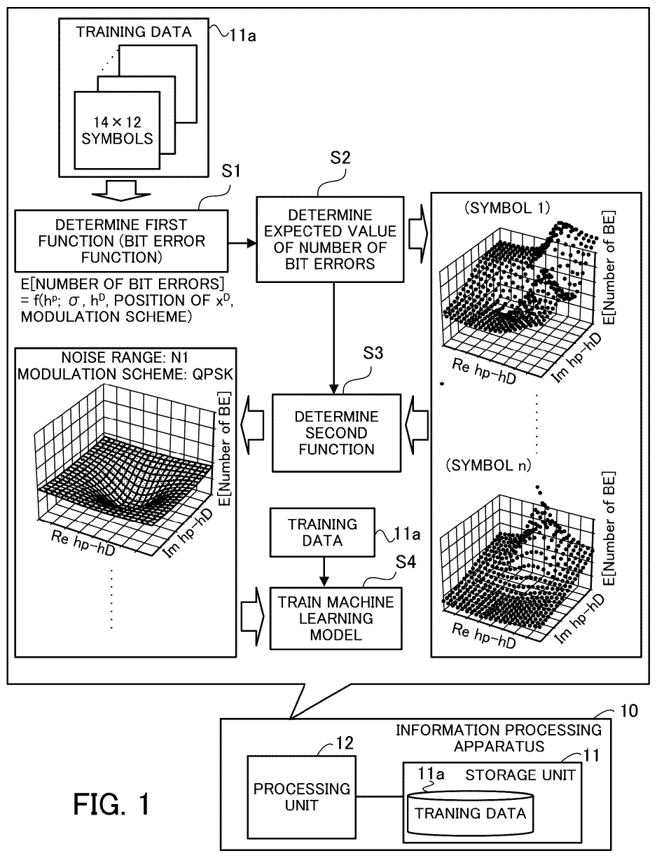

FIG. 1 depicts one example of a learning method according to a first embodiment. The learning method according to the first embodiment trains a machine learning model so as to output a channel estimation value capable of reducing the number of bit errors.

Note that FIG. 1 depicts an information processing apparatus 10 for implementing the learning method according to the first embodiment. The information processing apparatus 10 may implement the learning method according to the first embodiment by executing a learning program, for example.

The information processing apparatus 10 includes a storage unit 11 and a processing unit 12. As examples, the storage unit 11 is a memory or a storage device included in the information processing apparatus 10. As one example, the processing unit 12 is a processor included in the information processing apparatus 10. The information processing apparatus 10 may include a plurality of processors. A certain process and other processes out of a plurality of processes by the information processing apparatus 10 may be executed by different processors.

The storage unit 11 stores training data 11a. As one example, the training data 11a includes values related to noise in a propagation path of a transmission signal, a channel value, a position of the transmission signal on a complex plane, and a modulation scheme.

The relationship between the reception signal (y^{D}) and the transmission signal (x^{D}) is expressed by the Expression (1) below.

$${y}^{D} = {h}^{D} {x}^{D} + n , n ∼ CN ( 0 , 2 {σ}^{2} ) \qquad ( 1 )$$

In Expression (1), h^{D} indicates a channel value, and n indicates a complex noise value. The term “n~CN(0, 2σ²)” indicates that n follows a complex normal distribution with an average value of 0 and a variance of 2σ². Note that 2σ²=10^{-SNR[db]/10}. SNR is the signal-to-noise ratio.

In zero-forcing (ZF) demodulation, a reconstructed transmission signal (x^{ZF}) is expressed by the Expression (2) below using y^{D} and a channel estimation value (h^{P}).

$${x}^{ZF} = \frac{{y}^{D}}{{h}^{p}} = \frac{{h}^{D}}{{h}^{p}} {x}^{D} + \frac{n}{{h}^{p}} \qquad ( 2 )$$

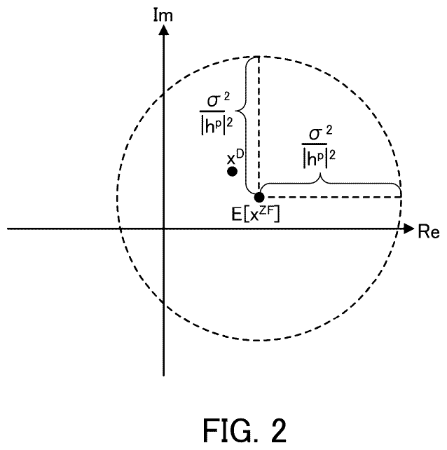

FIG. 2 depicts one example of a reconstructed transmission signal. In FIG. 2, the expected value (E[x^{ZF}]) of the transmission signal to be reconstructed is indicated together with x^{D} on a complex plane where the horizontal axis is the real axis (Re) and the vertical axis is an imaginary axis (Im). When the value of x^{ZF} is divided into a real part (Re x^{ZF}) and an imaginary part (Im x^{ZF}), the value of x^{ZF} follows a two-dimensional normal distribution as represented by Expression (3) below.

$$[ \begin{matrix}Re {x}^{ZF} \\ Im {x}^{ZF}\end{matrix} ] ∼ N ( [ \begin{matrix}Re ( {h}^{D} {x}^{D} / {h}^{p} ) \\ Im ( {h}^{D} {x}^{D} / {h}^{p} )\end{matrix} ] , {H}^{r} \sum {H}^{rT} ) \qquad ( 3 )$$

H^{r}ΣH^{rT} in Expression (3) may be expressed as Expression (5) using Expression (4).

$${H}^{r} = \frac{1}{{( Re {h}^{p} )}^{2} + {( Im {h}^{p} )}^{2}} [ \begin{matrix}Re {h}^{p} & Im {h}^{p} \\ - Im {h}^{p} & Re {h}^{p}\end{matrix} ] \qquad ( 4 )$$

$${H}^{r} \sum {H}^{rT} = \frac{1}{Re {h}^{p 2} + Im {h}^{p 2}} [ \begin{matrix}{σ}^{2} & 0 \\ 0 & {σ}^{2}\end{matrix} ] \qquad ( 5 )$$

As one example, σ in Expression (1) is used as a value related to noise included in the training data 11a.

In an OFDM scheme, the basic unit of a signal (referred to as a “resource block”) is determined at constant time intervals and frequency intervals.

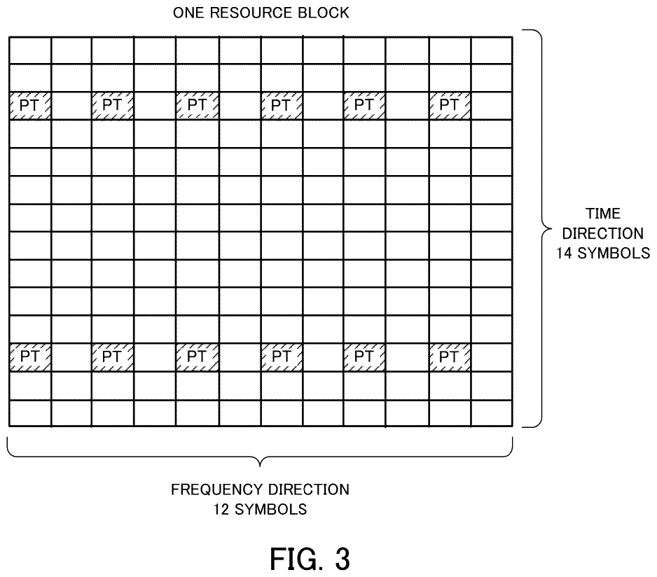

FIG. 3 illustrates a basic unit of a signal in an OFDM scheme. One resource block is composed of a signal with 14×12 symbols, that is, 12 symbols in the frequency direction and 14 symbols in the time direction.

In the OFDM scheme, a signal of a symbol at a predetermined position is a “pilot signal” (indicated as “PT” in FIG. 3). The pilot signal includes a value (fixed value) of x^{D} known at the reception side. Accordingly, a least square (LS) estimation value (h^{ls}) of the channel for a symbol in the pilot signal may be expressed as h^{ls}=y^{D}/x^{D}.

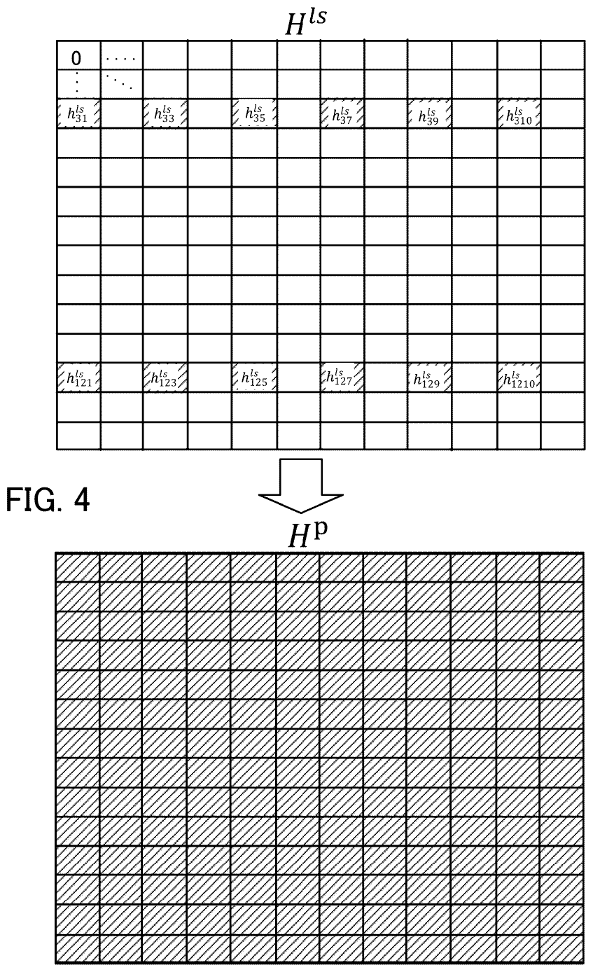

FIG. 4 depicts one example of channel estimation in an OFDM scheme. As a method of obtaining the channel estimation value H^{P} of an entire resource block, there is a method that performs two-dimensional linear interpolation of a matrix H^{ls} in which h^{ls}(h^{1s}₃₁, h^{ls}₃₃, or the like in FIG. 4) at a symbol in a pilot signal is used and the channel estimation values of other symbols are set at 0.

As a more accurate estimation method, there is a method of obtaining H^{P} by regarding the matrix H^{ls} as a low-resolution image and performing high-resolution processing using a machine learning model by a deep neural network (DNN). See, for example, Mehran Soltani, Vahid Pourahmadi, Ali Mirzaei, and Hamid Sheikhzadeh, “Deep Learning-Based Channel Estimation”, IEEE COMMUNICATIONS LETTERS, VOL. 23, NO. 4, APRIL 2019.

However, when a channel value is accurately estimated using a machine learning model, the number of parameters of the machine learning model will increase, which means that calculation load and memory usage will increase, resulting in an increase in overheads.

On the other hand, to reduce the number of bit errors, there may be no need to estimate the channel value with high accuracy.

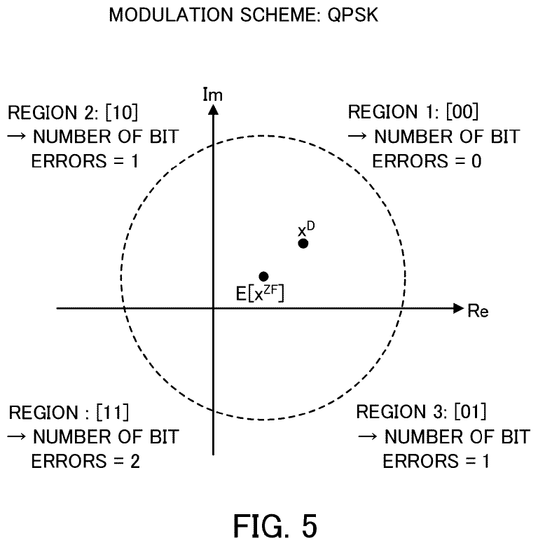

FIG. 5 depicts one example of the number of bit errors. FIG. 5 depicts an example where the modulation scheme of a transmission signal is quadrature phase shift keying (QPSK) and x^{D} is located in a region 1 on the complex plane.

When the modulation scheme is QPSK, the bit value of x^{D} is represented by the region out of the regions 1 to 4 on a complex plane in which x^{D} is located. When x^{D} is located in the region 1 where the real part and the imaginary part are both positive, the bit value is “00”. When x^{D} is located in the region 2 where the real part is negative and the imaginary part is positive, the bit value is “10”. When x^{D} is located in the region 3 where the real part is positive and the imaginary part is negative, the bit value is “01”. When x^{D} is located in the region 4 where the real part and the imaginary part are both negative, the bit value is “11”. In this way, the bit value is determined by the position of x^{D} on the complex plane.

When the expected value E[x^{ZF}] of the transmission signal to be reconstructed is located in the same region as x^{D}, no bit error occurs. When the expected value E[x^{ZF}] of the transmission signal to be reconstructed is located in a region aside from x^{D}, a bit error occurs. As one example, as depicted in FIG. 5, when E[x^{ZF}] is located in the same region, the region 1, as x^{D}, the number of bit errors=0. When E[x^{ZF}] is located in the region 2 or the region 3, the number of bit errors=1, and when E[x^{ZF}] is located in the region 4, the number of bit errors=2.

When x^{D} is located in the region 1 on the complex plane, the expected value of the number of bit errors (E[number of bit errors]) is expressed as E[number of bit errors]=0×p₁+p₂+p₃+2×p₄, where p₁ is the probability that the value of x^{ZF} falls in the region i.

It is possible to calculate p₁ using the two-dimensional normal distribution described earlier. As one example, p₁ is expressed by Expression (6) below using an error function erf.

$${p}_{1} = \frac{1}{4} ( erf ( \frac{∞ - Re \overline{h} {x}^{D}}{\sqrt{2} σ / {\vert {h}_{p} \vert}^{2}} ) - erf ( \frac{0 - Re \overline{h} {x}^{D}}{\sqrt{2} σ / {\vert {h}_{p} \vert}^{2}} ) ) \times ( erf ( \frac{∞ - Im \overline{h} {x}^{D}}{\sqrt{2} σ / {\vert {h}_{p} \vert}^{2}} ) - erf ( \frac{0 - Im \overline{h} {x}^{D}}{\sqrt{2} σ / {\vert {h}_{p} \vert}^{2}} ) ) \qquad ( 6 )$$

$$\overline{h} := {h}^{P} - {h}^{D}$$

As described above, when the value of x^{ZF} is located in the same region as x^{D}, the number of bit errors is 0. That is, there are cases where it is possible to reduce the number of bit errors without increasing the channel estimation accuracy to bring the value of x^{ZF} close to the value of x^{D}. By making use of this degree of freedom, it is possible to train the machine learning model to reduce the number of bit errors even when a machine learning model with a relatively small number of parameters is used.

As one example, the processing unit 12 executes a learning method in accordance with a processing procedure indicated by a learning program. The processing procedure of the learning method executed by the processing unit 12 is described below.

Step S1: The processing unit 12 determines a first function (hereinafter, referred to as a “bit error function”) representing an expected value of the number of bit errors in a transmission signal to be reconstructed. The transmission signal is reconstructed from the received signal using the channel estimation value as indicated in Expression (2).

As described above, the expected value of the number of bit errors changes depending on the value of h^{P}, the modulation scheme, the value of a (or SNR), the value of h^{D}, and the position of x^{D}. For this reason, the bit error function determined by the processing unit 12 is a function that expresses an expected value of the number of bit errors determined according to the value of h^{P}, the modulation scheme, the value of a (or SNR), the value of h^{D}, and the position of x^{D}. The bit error function is E[number of bit errors]=f(h^{P}; σ, h^{D}, position of x^{D}, modulation scheme).

As one method, the processing unit 12 uses a bit error function as a loss function of a machine learning model and train the machine learning model so that EE[the number of bit errors]=Σf(h^{P}; σ, h^{D}, the position of x^{D}, and the modulation scheme) is minimized.

However, in the training data 11a, although the modulation scheme, the value of σ, the value of h^{D}, and the position of x^{D} are known for the signals of every symbol, the value of h^{D} and the position of x^{D} are unclear when reconstruction of the transmission signal is actually performed. Since the position on the complex plane of the value of x^{D} that was transmitted is unknown, a bit error function that has been averaged at each position is used. As one example, when the modulation scheme is QPSK, ¼ (f_{QPSK,1}+ . . . +f_{QPSK,4}) (h^{P}; σ, h^{D}) is used. f_{QPSK,i} is the bit error function when x^{D} is located in the region i.

However, since the value of h^{D} that determines the shape of the bit error function is unknown when reconstructing the transmission signal, training the machine learning model using h^{D} of the training data 11a may result in overtraining and the number of bit errors may increase. Also, when the bit error function is averaged with respect to the channel value, the scale of the equation increases.

For this reason, in the learning method according to the first embodiment, the processing unit 12 performs the processing of step S2 onward as depicted in FIG. 1.
Step S2: After the bit error function is determined, the processing unit 12 determines an expected value of the number of bit errors (E[the number of bit errors]) for a plurality of candidates of h^{P} using the training data 11a and the bit error function. Values that are close to h^{D} are used as the plurality of candidates of h^{P}. E[the number of bit errors] is determined for each symbol in the training data 11a.

FIG. 1 depicts examples of expected values of the number of bit errors determined for n symbols by way of a plurality of sample points. “Re hp−hD” represents the difference between the real part of h^{P} and the real part of h^{D}, and “Im hp−hD” represents the difference between the imaginary part of h^{P} and the imaginary part of h^{D}. “E[Number of BE]” represents the expected value of the number of bit errors. The shape of the set of sample points varies depending on the value of σ, the value of h^{D}, the position of x^{D}, or the modulation scheme between symbols.

When the training data 11a includes data for 1000 resource blocks, the expected value of E[the number of bit errors] is determined for n=14×12×1000 symbols.
Step S3: The processing unit 12 determines a second function that approximates the bit error function based on the determined expected values of the number of bit errors.

As one example, the processing unit 12 averages sample points for expected values of the number of bit errors for each SNR and modulation scheme. The processing unit 12 then determines a function that has been fitted to the averaged sample points as the second function.

FIG. 1 depicts an example of the second function obtained when the range of noise (SNR) is N1 and the modulation scheme is QPSK. This second function is a simpler function than E[number of bit errors]=f (h^{P}; σ, h^{D}, position of x^{D}, modulation scheme), such as a function with a lower number of parameters.
Step S4: The processing unit 12 trains a machine learning model in which the second function is a loss function by using the training data 11a.

As examples of the machine learning model, a DNN such as a convolutional neural network (CNN), a recurrent neural network (RNN), or Transformer may be used. The processing unit 12 trains the machine learning model such that the sum of the SNR and the loss function obtained for each modulation scheme is minimized. By doing so, a machine learning model that outputs channel estimation values of all symbols when known channel values of some of the symbols are inputted is obtained as depicted in FIG. 4. Information on the trained machine learning model may be stored in the storage unit 11. As examples, values of parameters such as a weighting or bias for each layer of the DNN are stored as information on the machine learning model.

According to the above learning method, as described earlier, when the value of x^{ZF} is located in the same region as x^{D}, it is possible to make use of the increased freedom of channel estimation whereby the number of bit errors may be 0 even without the channel estimation accuracy being increased to bring the value of x^{ZF} close to the value of x^{D}. Such freedom is reflected in the second function determined as described above. The second function has a gentler shape than the mean square error function. By training the machine learning model using the second function as a loss function, it is possible to reduce the number of bit errors even when a machine learning model with a small number of parameters is used.

### Second Embodiment

Next, a second embodiment will be described.

The information processing apparatus 100 according to the second embodiment trains a machine learning model so as to reduce the number of error bits. This machine learning model outputs channel estimation values of every symbol when known channel values of some of the symbols have been inputted. The information processing apparatus 10 may be a client apparatus or a server apparatus. The information processing apparatus 100 may be referred to as a “computer”.

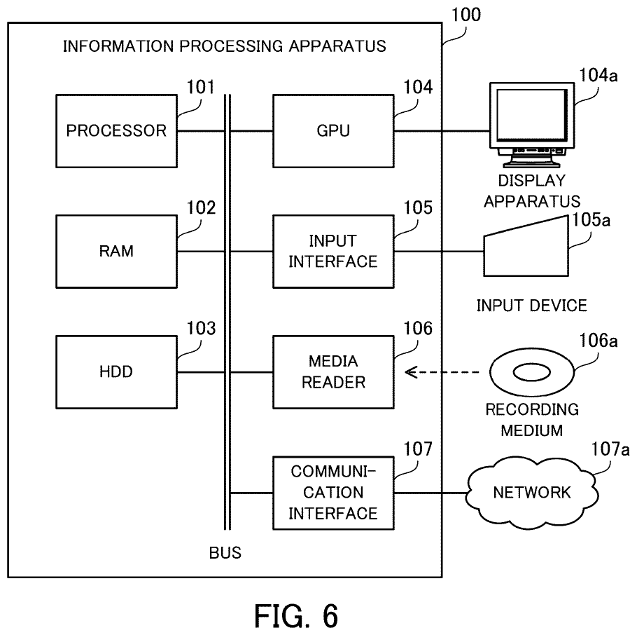

FIG. 6 is a block diagram depicting example hardware of the information processing apparatus.

The information processing apparatus 100 includes a processor 101, a random access memory (RAM) 102, a hard disk drive (HDD) 103, a graphics processing unit (GPU) 104, an input interface 105, a media reader 106, and a communication interface 107, which are connected to a bus. The processor 101 corresponds to the processing unit 12 of the first embodiment. The RAM 102 or the HDD 103 corresponds to the storage unit 11 of the first embodiment.

The processor 101 is a processor such as a GPU or a central processing unit (CPU) including a computational circuit that executes instructions of a program. The processor 101 loads at least a part of a program and data stored in the HDD 103 into the RAM 102 and executes the program. Note that the processor 101 may include a plurality of processor cores. The information processing apparatus 100 may include a plurality of processors. A processor that executes a certain process out of a plurality of processes performed by the information processing apparatus 100 may differ from a processor that executes processes out of the plurality of processes aside from the certain process. The processor may be referred to as “processor circuitry”. A group of a plurality of processors (or “multiprocessor”) may also be referred to as a “processor”.

The RAM 102 is a volatile semiconductor memory that temporarily stores a program to be executed by the processor 101 and data to be used for computation by the processor 101. The information processing apparatus 100 may include a volatile memory of a type aside from RAM.

The HDD 103 is nonvolatile storage that stores software programs, such as an operating system (OS), middleware, and application software, and data. The information processing apparatus 100 may include another type of nonvolatile storage such as flash memory or a solid state drive (SSD).

The GPU 104 performs image processing in cooperation with the processor 101, and outputs an image to a display apparatus 104a connected to the information processing apparatus 100. As examples, the display apparatus 104a is a cathode ray tube (CRT) display, a liquid crystal display, an organic electro luminescence (EL) display, or a projector. Another type of output device, such as a printer, may be connected to the information processing apparatus 100.

The GPU 104 may be used as a general purpose computing on graphics processing unit (GPGPU). The GPU 104 may execute a program in response to an instruction from the processor 101. The information processing apparatus 100 may include volatile semiconductor memory aside from the RAM 102 as a GPU memory.

The input interface 105 receives an input signal from an input device 105a connected to the information processing apparatus 100. As examples, the input device 105a is a mouse, a touch panel, or a keyboard. A plurality of input devices may be connected to the information processing apparatus 100.

The media reader 106 is a reader apparatus that reads a program and data recorded on a recording medium 106a. As examples, the recording medium 106a is a magnetic disk, an optical disc, or a semiconductor memory. Magnetic disks include a flexible disk (FD) and an HDD. Optical discs include a compact disc (CD) and a digital versatile disc (DVD). The media reader 106 copies the program and data read from the recording medium 106a onto another recording medium such as the RAM 102 or the HDD 103. Alternatively, a program that has been read may be executed by the processor 101.

The recording medium 106a may be a portable recording medium. The recording medium 106a may be used for distribution of programs and data. The recording medium 106a and the HDD 103 may be referred to as “computer-readable recording media”.

The communication interface 107 communicates with other information processing apparatuses via a network 107a. The communication interface 107 may be a wired communication interface connected to a wired communication apparatus, such as a switch or a router, or may be a wireless communication interface connected to a wireless communication apparatus, such as a base station or an access point.

Next, functions of the information processing apparatus 100 will be described.

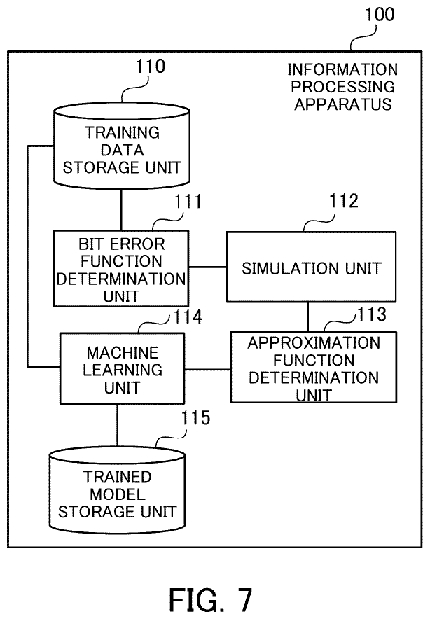

FIG. 7 is a block diagram depicting example functions of the information processing apparatus.

The information processing apparatus 100 includes a training data storage unit 110, a bit error function determination unit 111, a simulation unit 112, an approximation function determination unit 113, a machine learning unit 114, and a trained model storage unit 115. As one example, the training data storage unit 110 and the trained model storage unit 115 are implemented using storage areas reserved in the RAM 102 or the HDD 103. The bit error function determination unit 111, the simulation unit 112, the approximation function determination unit 113, the machine learning unit 114, and the trained model storage unit 115 are implemented using program modules executed by the processor 101, for example.

The training data storage unit 110 stores training data. As examples, this training data includes a value related to noise on a propagation path of a transmission signal, a value of a channel, a position of the transmission signal on a complex plane, and a modulation scheme.

The bit error function determination unit 111 determines a bit error function representing an expected value of the number of bit errors in the transmission signal to be reconstructed. The bit error function is E[number of bit errors]=f(h^{P}; σ, h^{D}, position of x^{D}, modulation scheme).

The simulation unit 112 determines an expected value of the number of bit errors (E[number of bit errors]) for a plurality of candidates of h^{P} by simulation using the training data and the bit error function. Values that are close to h^{D} are used as a plurality of candidates for h^{P}. E[the number of bit errors] is determined for each symbol in the training data. When channel estimation is performed for OFDM wireless communication, data of 14×12 symbols per resource block is used as training data (see FIG. 3 described earlier).

The approximation function determination unit 113 determines an approximation function, which approximates the bit error function, based on the determined expected value of the number of bit errors. This approximation function corresponds to the second function in the first embodiment. A specific example of a method of determining the approximation function will be described later.

The machine learning unit 114 uses training data to train a machine learning model with an approximation function as a loss function. As examples of the machine learning model, a DNN such as a CNN, an RNN, or Transformer may be used. The machine learning unit 114 trains the machine learning model so that the sum of the SNR and the loss function determined for each modulation scheme is minimized.

The trained model storage unit 115 stores information on a trained machine learning model. As one example, values of parameters such as a weighting or bias for each layer of the DNN is stored as information on the machine learning model.

As described in the first embodiment, in order to suppress the number of bit errors, there may be no need to match the estimation value of the channel to the true value of the channel. The reason for this is described in detail below.

### (Reason Why Estimation Value of Channel Does Not Need to Match True Value of Channel)

Consider the problem of minimizing the total number of bit errors of two signals (symbols). This minimization problem is expressed by the Expression (7) below.

$${min}_{θ} {f}_{1} ( {h}_{1}^{p} ) + {f}_{2} ( {h}_{2}^{p} ) \qquad ( 7 )$$

$$sub . to {h}_{1}^{p} = DNN ( {h}_{1}^{ls} ; θ ) , {h}_{2}^{p} = DNN ( {h}_{2}^{ls} ; θ )$$

In Expression (7), f₁(h^{P}₁) is an expected value of the number of bit errors with respect to the estimation value (h^{P}₁) of the channel. f₂(h^{P}₂) is the expected value of the number of bit errors for the channel estimate (h^{P}₂). θ is a parameter of a DNN which is an example of a machine learning model. h^{ls}₁ and h^{ls}₂ are channel LS estimation values (see FIG. 4 described earlier) for a symbol in the pilot signal. h^{ls}₁ and h^{ls}₂ are inputs of the DNN.

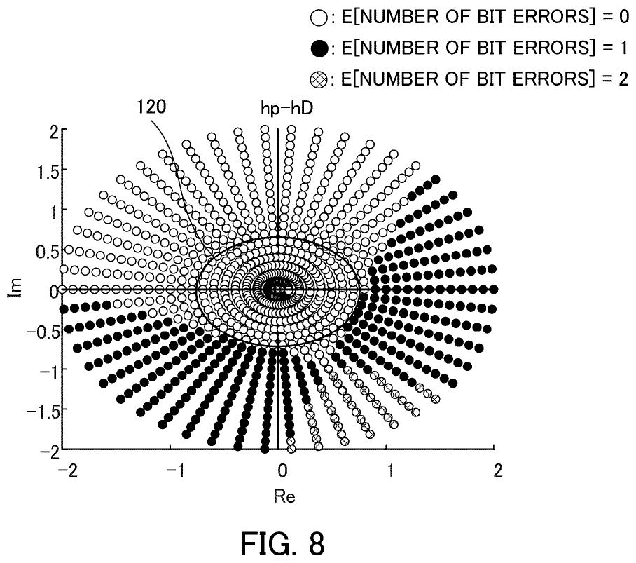

FIG. 8 depicts the relationship between a difference between an estimation value and a true value of a channel and an expected value of the number of bit errors. The horizontal axis represents the real part of the difference (h^{P}−h^{D}) between the estimation value (h^{P}) and the true value (h^{D}), and the vertical axis represents the imaginary part of the difference (h^{P}−h^{D}).

A set 120 represents a set of h^{P} in a range in which the Euclidean distance between h^{P} and h^{D} is shorter than a threshold (γ). The set 120 is expressed by the following Expression (8) below.

$${D}_{Dist} := \{ {h}^{p} : {‖ {h}^{p} - {h}^{D} ‖}_{2} < γ \} \qquad ( 8 )$$

On the other hand, a set of h^{P} in which the expected value of the number of bit errors is 0 is expressed by Expression (9) below.

$${D}_{res} := \{ {h}^{p} : {f}_{1} ( {h}_{p} ) = 0 \} \qquad ( 9 )$$

Since f₁(h^{P}₁)=0 when h^{P}₁∈D_{Dist}, the value of min_{θ}f₁ (h^{P}₁)+f₂ (h^{P}₂) in Expression (7) is as indicated in Expression (10) below.

$${min}_{θ} {f}_{1} ( {h}_{1}^{p} ) + {f}_{2} ( {h}_{2}^{p} ) = {min}_{{h}_{1}^{p} ∈ {D}_{Dist}} {f}_{2} ( {h}_{2}^{p} ) \qquad ( 10 )$$

Since f₁(h^{P}₁)=0 when h^{P}₁∈Dᵣₑₛ, the value of min_{θ}f₁ (h^{P}₁)+f₂ (h^{P}₂) in Expression (7) is as indicated in Expression (11) below.

$${min}_{θ} {f}_{1} ( {h}_{1}^{p} ) + {f}_{2} ( {h}_{2}^{p} ) = {min}_{{h}_{1}^{p} ∈ {D}_{res}} {f}_{2} ( {h}_{2}^{p} ) \qquad ( 11 )$$

Here, since D_{Dist}⊆Dᵣₑₛ, the relationship of the following Expression (12) holds.

$${min}_{{h}_{1}^{p} ∈ {D}_{Dist}} {f}_{2} ( {h}_{2}^{p} ) ≧ {min}_{{h}_{1}^{p} ∈ {D}_{res}} {f}_{2} ( {h}_{2}^{p} ) \qquad ( 12 )$$

That is, when there is little need to bring h^{P}₁ close to h^{D}₁, it is possible to reduce the number of bit errors of the other signal.

The same applies to a case where there is no region where f₁ (h^{P}₁)=0. In this case, D_{Dist} and Dᵣₑₛ are expressed by Expressions (13) and (14) below instead of Expressions (8) and (9).

$${D}_{Dist} := \{ {h}^{p} : \vert {h}^{p} - {h}^{D} \vert \leq {γ}_{Dist} , {f}_{1} ( {h}_{1}^{p} ) \leq ϵ \} \qquad ( 13 )$$

$${D}_{res} := \{ {h}^{p} : {f}_{1} ( {h}^{p} ) \leq {γ}_{res} , {f}_{1} ( {h}_{1}^{p} ) \leq ϵ \} \qquad ( 14 )$$

Since f₁ (h^{P}₁)≤ε when h^{P}₁∈D_{Dist}, the value of min_{θ}f₁ (h^{P}₁)+f₂ (h^{P}₂) in Expression (7) is as indicated in Expression (15) below.

$${min}_{θ} {f}_{1} ( {h}_{1}^{p} ) + {f}_{2} ( {h}_{2}^{p} ) = ϵ + {min}_{{h}_{1}^{p} ∈ {D}_{Dist}} {f}_{2} ( {h}_{2}^{p} ) \qquad ( 15 )$$

Since f₁(h^{P}₁)≤ε when h^{P}₁ ∈Dᵣₑₛ, the value of min_{θ}f₁ (h^{P}₁)+f₂ (h^{P}₂) in Expression (7) is as indicated in Expression (16) below.

$${min}_{θ} {f}_{1} ( {h}_{1}^{p} ) + {f}_{2} ( {h}_{2}^{p} ) = ϵ + {min}_{{h}_{1}^{p} ∈ {D}_{res}} {f}_{2} ( {h}_{2}^{p} ) \qquad ( 16 )$$

Here, when D_{Dist}⊆Dᵣₑₛ, the relationship in Expression (12) described earlier holds. As described earlier, when the value of x^{ZF} is located in the same region as x^{D}, the number of bit errors is 0, so D_{Dist}⊆Dᵣₑₛ is expected to hold.

### Example Simulation Result of Expected Value of Number of Bit Errors

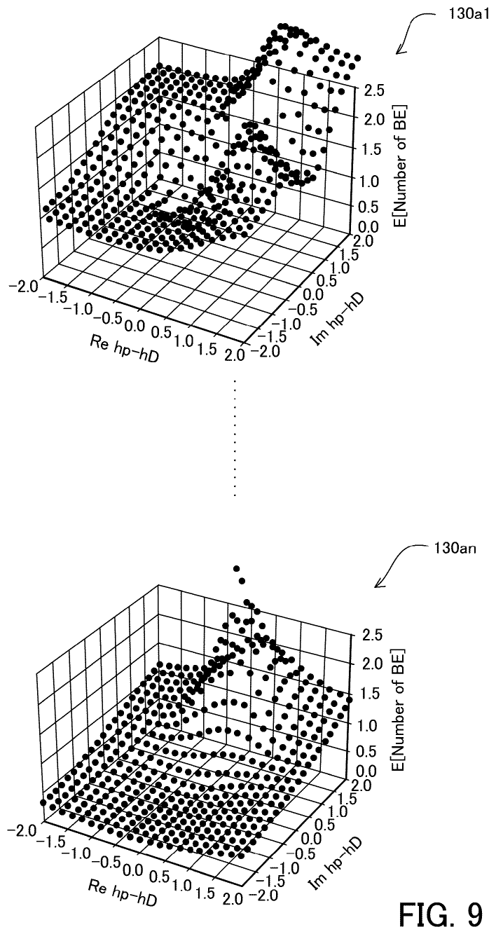

FIG. 9 depicts one example of a simulation result of an expected value of the number of bit errors. FIG. 9 depicts simulation results 130a1 to 130an. “Re hp−hD” represents the difference between the real part of h^{P} and the real part of h^{D}, and “Im hp−hD” represents the difference between the imaginary part of h^{P} and the imaginary part of h^{D}. “E[Number of BE]” represents an expected value of the number of bit errors.

When channel estimation for OFDM wireless communication is performed using training data for 1000 resource blocks for example, an expected value of the number of bit errors is determined for each of n=14×12×1000 symbols. The shape of the set of sample points differs depending on the value of h^{P}, the modulation scheme, the value of σ (or SNR), the value of h^{D}, or the position of x^{D} of the training data.

### Example Method of Determining Approximation Function

The approximation function determination unit 113 averages the expected values of the number of bit errors for each SNR or each modulation scheme.

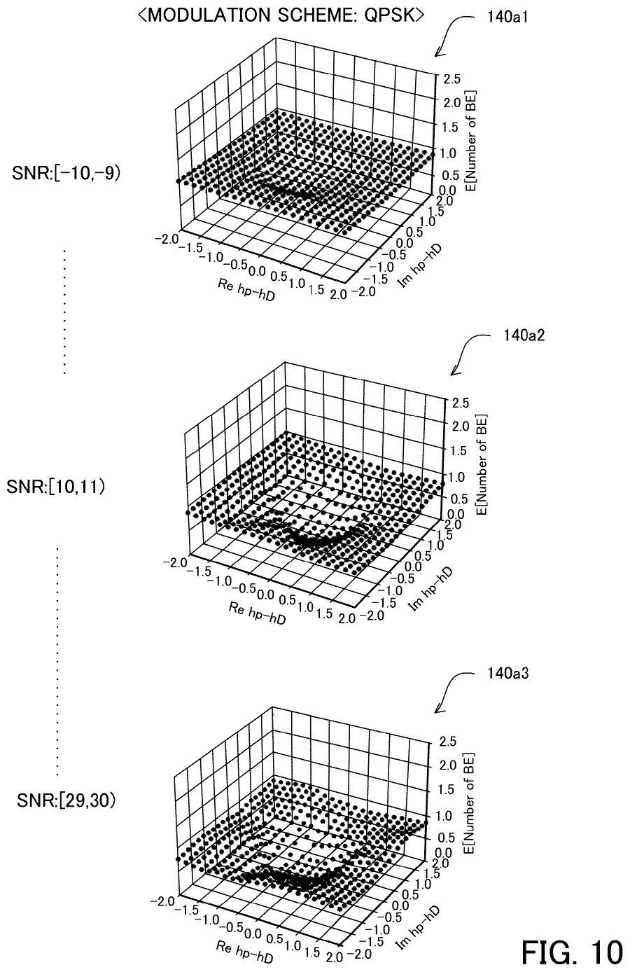

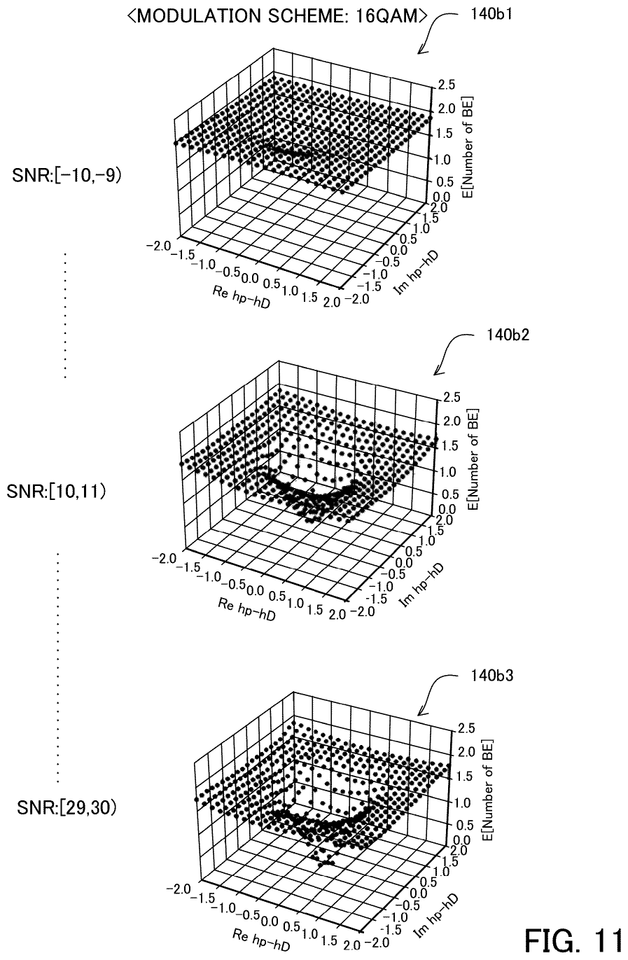

FIG. 10 depicts examples of the expected values of the averaged number of bit errors when the modulation scheme is QPSK. FIG. 11 depicts examples of the expected values of the averaged number of bit errors when the modulation scheme is 16QAM. FIGS. 10 and 11 depict calculation results of expected values of the number of bit errors averaged for various values of h^{P} in a range of a plurality of SNR. In the examples of FIGS. 10 and 11, averaging is performed for SNR ranges of 1 dB.

In FIG. 10, a calculation result 140a1 is a calculation result of an expected value of the number of bit errors averaged in a range where the modulation scheme is QPSK and the SNR is −10 dB or more but less than −9 dB. The calculation result 140a2 is a calculation result of an expected value of the number of bit errors averaged in a range where the modulation scheme is QPSK and the SNR is 10 dB or more but less than 11 dB. The calculation result 140a3 is a calculation result of an expected value of the number of bit errors averaged in a range where the modulation scheme is QPSK and the SNR is 29 dB or more but less than 30 dB.

In FIG. 11, a calculation result 140b1 is a calculation result of an expected value of the number of bit errors averaged in a range where the modulation scheme is 16QAM and the SNR is −10 dB or more but less than −9 dB. The calculation result 140b2 is a calculation result of an expected value of the number of bit errors averaged in a range where the modulation scheme is 16QAM and the SNR is 10 dB or more but less than 11 dB. The calculation result 140b3 is a calculation result of an expected value of the number of bit errors averaged in a range where the modulation scheme is 16QAM and the SNR is 29 dB or more but less than 30 dB.

The shape of the set of sample points of the averaged expected value of the number of bit errors is gentler than the shape of the set of expected values of the number of bit errors depicted in FIG. 9.

Next, the approximation function determination unit 113 determines an approximation function that approximates to the error bit function by fitting a function to the averaged expected values. As one example, the sets of sample points depicted in FIGS. 10 and 11 favorably fit a function g represented by Expression (17) below.

$$g ( Re \overline{h} , Im \overline{h} ) = - {a}_{0} cos ( {a}_{1} Re \overline{h} ) cos ( {a}_{1} Im \overline{h} ) exp ( - {a}_{2} ( Re {\overline{h}}^{2} ) - {{a}_{2} ( Im \overline{h} )}^{2} ) + {a}_{3} {Re ( \overline{h} )}^{2} + {{a}_{3} ( Im \overline{h} )}^{2} + {a}_{4} \qquad ( 17 )$$

$$\overline{h} := {h}^{p} - {h}^{D} ,$$

$${a}_{i} = {b}_{i} \times SNR + {c}_{i}$$

The function g is an extension of the Easom function. b₁ and c₁ are fitting parameters.

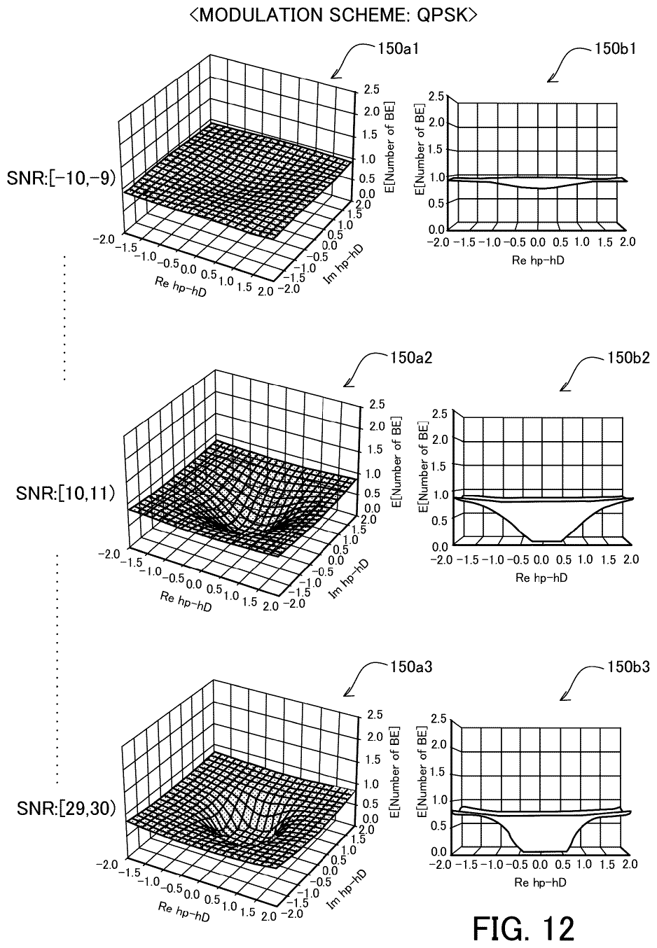

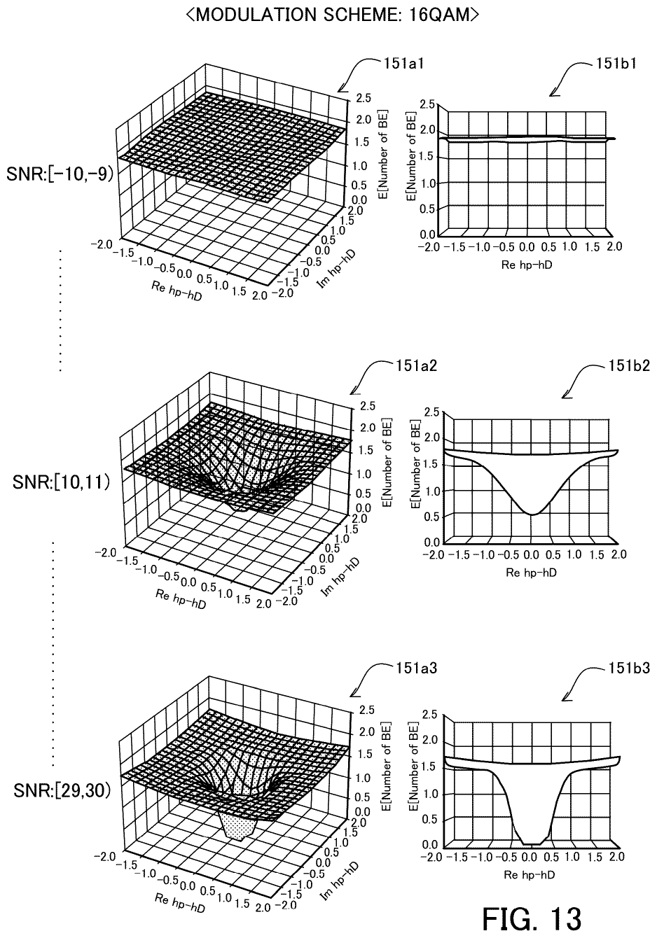

FIG. 12 depicts example results of fitting the function g when the modulation scheme is QPSK. FIG. 13 depicts example results of fitting the function g when the modulation scheme is 16QAM. FIGS. 12 and 13 depict fitting results for the calculation results of the averaged expected values of the number of bit errors in the plurality of SNR ranges depicted in FIGS. 10 and 11.

In FIG. 12, fitting results 150a1 and 150b1 are fitting results for the calculation result 140a1 of the expected value of the number of bit errors averaged in a range where the modulation scheme is QPSK and the SNR is −10 dB or more but less than −9 dB. The fitting results 150a2 and 150b2 are fitting results for the calculation result 140a2 of the expected value of the number of bit errors averaged in a range where the modulation scheme is QPSK and the SNR is 10 dB or more but less than 11 dB. The fitting results 150a3 and 150b3 are fitting results for the calculation result 140a3 of the expected value of the number of bit errors averaged in the range where the modulation scheme is QPSK and the SNR is 29 dB or more but less than 30 dB. Note that the fitting results 150b1 to 150b3 are simplified outlines of the fitting results 150a1 to 150a3 viewed from a different angle.

In FIG. 13, fitting results 151a1 and 151b1 are fitting results with respect to the calculation result 140b1 of the expected value of the number of bit errors averaged in a range where the modulation scheme is 16QAM and the SNR is −10 dB or more but less than −9 dB. The fitting results 151a2 and 151b2 are fitting results for the calculation result 140b2 of the expected value of the number of bit errors averaged in a range where the modulation scheme is 16QAM and the SNR is 10 dB or more but less than 11 dB. The fitting results 151a3 and 151b3 are fitting results for the calculation result 140b3 of the expected value of the number of bit errors averaged in a range where the modulation scheme is 16QAM and the SNR is 29 dB or more but less than 30 dB. Note that the fitting results 151b1 to 151b3 are simplified outlines of the fitting results 151a1 to 151a3 viewed from a different angle.

As depicted in FIGS. 12 and 13, in each of the fitting results, the function value is minimized when the values of the real part and the imaginary part of h^{P}−h^{D} are 0. The shape of the function obtained by the fitting result is also sharper when the modulation scheme is 16QAM than when the modulation scheme is QPSK. For 16QAM, the shape becomes sharper as the SNR value increases.

As another example of the approximation function, a function that has a minimum value when the values of the real part and the imaginary part of h^{P}−h^{D} are 0 and is downwardly convex may be used. One example of such a function is a Sphere function.

### (Procedure of Learning Method)

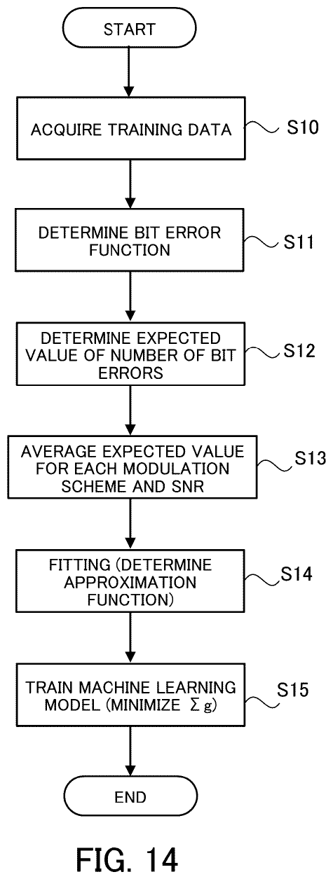

FIG. 14 is a flowchart depicting a processing procedure of the learning method according to the second embodiment.
Step S10: The information processing apparatus 100 acquires the training data. The training data may be acquired from the recording medium 106a or may be acquired (received) from another computer via the network 107a. The acquired training data is stored in the RAM 102 or the HDD 103.
Step S11: The information processing apparatus 100 determines a bit error function (E[number of bit errors]=f(h^{P}; σ, h^{D}, position of x^{D}, modulation scheme)) expressing an expected value of the number of bit errors in a reconstructed transmission signal.
Step S12: The information processing apparatus 100 determines an expected value of the number of bit errors (E[number of bit errors]) for a plurality of candidates of h^{P} by simulation using the training data and the bit error function as depicted in FIG. 9.
Step S13: The information processing apparatus 100 averages the expected values of the number of bit errors for each modulation scheme or SNR as depicted in FIGS. 10 and 11.
Step S14: The information processing apparatus 100 determines an approximation function by fitting the function g to the sample points of the averaged expected value of the number of bit errors as depicted in FIGS. 12 and 13.
Step S15: The information processing apparatus 100 uses the training data to train a machine learning model that has an approximation function as a loss function. The information processing apparatus 100 trains the machine learning model so that the sum of the SNR and the loss function obtained for each modulation scheme (the sum (Σg) of the function g) is minimized. As a result, a machine learning model that outputs channel estimation values of all symbols when known channel values of some of the symbols are inputted is obtained, as depicted in FIG. 4.

The information of the obtained machine learning model (for example, values of parameters such as a weighting or a bias for each layer in a DNN) is stored in the RAM 102 or the HDD 103, for example. This information on the machine learning model may be transmitted to another computer via the network 107a.

This completes the processing of the learning method according to the second embodiment. Note that the information processing apparatus 100 may use the trained machine learning model to perform an inference process that obtains an estimation value of the channel for an entire resource block from the LS estimation value (h^{ls}) of the channel for a symbol in a pilot signal in the resource block. In addition, the information processing apparatus 100 may reconstruct the transmission signal based on the received signal and the estimation value of the channel obtained in the inference process.

### Evaluation Results

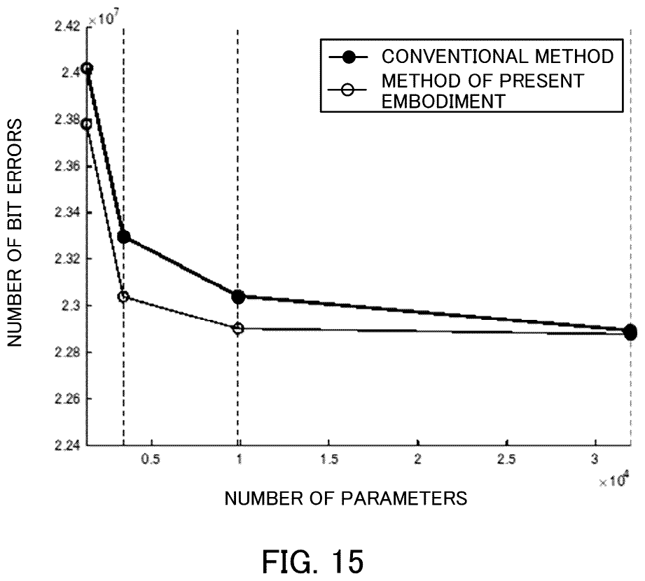

FIG. 15 depicts an evaluation result indicating a relationship between the number of parameters of the machine learning model and the number of bit errors. In FIG. 15, as described above, the matrix H^{ls} is regarded as a low-resolution image, and an evaluation result for a case that applies a conventional method of obtaining H^{P} by performing high-resolution processing using a machine learning model using a DNN is compared with an evaluation result for a case that applies the method of the present embodiment.

When the number of parameters decreases, the number of bit errors is smaller when the method of the present embodiment is applied than when the conventional method is applied. That is, by applying the method of the present embodiment, the number of bit errors is suppressed even when the number of parameters is reduced to reduce overheads.

In one aspect, the number of bit errors is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
determining a first function that expresses an expected value of a number of bit errors in a transmission signal to be reconstructed from a received signal using an estimation value of a channel;
determining the expected value for a plurality of candidates of the estimation value using training data and the first function;
determining a second function that approximates the first function based on the determined expected value; and
training a machine learning model, which uses the second function as a loss function, using the training data.

2. The non-transitory computer-readable recording medium according to claim 1, wherein a value of the first function is determined according to the estimation value, a value relating to noise on a propagation path of the transmission signal, a value of the channel, a position of the transmission signal on a complex plane, or a modulation scheme.

3. The non-transitory computer-readable recording medium according to claim 1, wherein the training data includes a value relating to noise on a propagation path of the transmission signal, a value of the channel, a position of the transmission signal on a complex plane, and a modulation scheme.

4. The non-transitory computer-readable recording medium according to claim 1, wherein the determining of the second function includes
averaging the expected value for each value relating to noise on the propagation path of the transmission signal or for each modulation scheme; and
determining the second function by performing fitting a function to the averaged expected values.

5. The non-transitory computer-readable recording medium according to claim 4, wherein the fitting of a function is performed using an Easom function.

6. The non-transitory computer-readable recording medium according to claim 4, wherein the training of the machine learning model includes training the machine learning model so that a sum of the second function determined for each of the expected values that have been averaged either for each value relating to the noise or for each modulation scheme is minimized.

7. A learning method comprising:
determining, by a processor, a first function that expresses an expected value of a number of bit errors in a transmission signal to be reconstructed from a received signal using an estimation value of a channel;
determining, by the processor, the expected value for a plurality of candidates of the estimation value using training data and the first function;
determining, by the processor, a second function that approximates the first function based on the determined expected value; and
training, by the processor, a machine learning model, which uses the second function as a loss function, using the training data.

8. An information processing apparatus comprising:
a memory configured to store training data; and
a processor coupled to the memory and the processor configured to:
determine a first function that expresses an expected value of a number of bit errors in a transmission signal to be reconstructed from a received signal using an estimation value of a channel;
determine the expected value for a plurality of candidates of the estimation value using the training data and the first function;
determine a second function that approximates the first function based on the determined expected value; and
train a machine learning model, which uses the second function as a loss function, using the training data.
